(19) United States
(12) Patent Application Publication
(10) Pub. No.: US 2007/0047005 A1
(43) Pub. Date: Mar. 1, 2007

(54) Image forming system and method

(75) Inventor: Kyeong-man Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/506,919

(22) Filed: Aug. 21, 2006

(30) Foreign Application Priority Data
Sep. 1, 2005 (KR) 2005-0081335

(51) Int. Cl. G06K 9/00

(52) U.S. Cl. 358/302; 382/132

(57) ABSTRACT

Provided are an image forming system and an image forming method. In the system, a film scanner is separable or separate from and is connectable or communicably coupled to an image forming apparatus. The image forming apparatus controls the film scanner to receive image data generated by the film scanner. Accordingly, the size of the image forming system can be reduced, and since the film scanner is separable or separate from the image forming apparatus, a user can conveniently use the film scanner.

### CROSS-REFERENCE TO RELATED PATENT APPLICATION

This application claims the benefit under 35 U.S.C. §119(a) of a Korean Patent Application No. 10-2005-0081335, filed on Sep. 1, 2005, in the Korean Intellectual Property Office, the entire disclosure of which is hereby incorporated by reference.

### BACKGROUND OF THE INVENTION

1. Field of the Invention

The present invention relates to an image forming system. More particularly, the present invention relates to an image forming system printing image data by using an image forming apparatus to control a film scanner that is located apart from and is connectable to the image forming apparatus and an image forming method thereof.

2. Description of the Related Art

FIG. 1 is a conceptual diagram of a conventional image forming system 100, which includes a film scanner 120 and a printer 130.

As illustrated in FIG. 1, the film scanner 120 and the printer 130 are embedded in one body. The film scanner 120 scans a film 110 that is photographed in an analog method and developed. The printer 130 prints image data. Thereby, an image scanned by the film scanner 120 is printed by the printer 130.

However, the conventional image forming system 100 is large. Furthermore, despite the film scanner 120 having a specific function different from the printer 130, film scanner 120 cannot be used separately from the printer 130.

Accordingly, there is a need for an improved image forming system that has a reduced size and allows the film scanner to be used separately from the printer.

### SUMMARY OF THE INVENTION

Exemplary embodiments of the present invention address at least the above problems and/or disadvantages and provide at least the advantages described below. Accordingly, an aspect of the present invention is to provide an image forming system that prints image data by using an image forming apparatus to control a film scanner that is separable or separated from and connectable or communicably coupled to the image forming apparatus and an image forming method.

According to an aspect of the present invention, there is provided an image forming system in which a film scanner is separable or separated from and is connectable or communicably coupled to the image forming apparatus, and the image forming apparatus controls the film scanner and receives image data generated by the film scanner.

The image forming apparatus may comprise a controller for controlling the film scanner; a receiver for receiving the generated image data by controlling the controller; and a printing unit for printing the received image data.

The film scanner may comprise a data generator for generating image data by scanning a developed film; and a transmitter for transmitting the generated image data to the image forming apparatus.

The receiver and the transmitter may be connected and/or communicably coupled to each other in at least one of a wired and/or wireless manner.

The film scanner may further comprise a data recorder for writing the generated image data in a storage medium, and the image forming apparatus may further comprise a data reader for reading the written image data from the storage medium.

The image forming apparatus may further comprise an image processing unit for performing an image processing operation on the received image data, wherein the printing unit prints the image-processed image data.

The film scanner may be portable.

The film scanner and the image forming apparatus may support a PictBridge™ function.

According to another aspect of the present invention, there is provided a film scanner comprising a data transmitter transmitting generated image data to an image forming apparatus according to a control of the image forming apparatus, wherein the film scanner is separated from and connectable to the image forming apparatus.

The film scanner may further comprise a data recorder writing the generated image data in a storage medium.

The film scanner may be portable.

The film scanner may support a PictBridge™ function.

According to another aspect of the present invention, there is provided an image forming apparatus comprising a controller for controlling a film scanner, the film scanner being separable or separate from and being connectable or communicably coupled to the image forming apparatus, to receive image data generated by scanning a film in the film scanner; and a printing unit for printing the received image data.

The image forming apparatus may support a PictBridge™ function.

According to an aspect of the present invention, there is provided an image forming method for an image forming system, the method comprising connecting a film scanner to an image forming apparatus; generating image data by scanning a film; receiving the generated image data by controlling the film scanner at the image forming apparatus; and printing the received image data in the image forming apparatus.

The method may further comprise determining whether the image forming apparatus and the film scanner are compatible; and terminating the connection between the image forming apparatus and the film scanner if the image forming apparatus and the film scanner are not compatible

The method may further comprise performing image processing of the transmitted image data, wherein the printing comprises printing the image-processed image data.

The film scanner may be portable.

The film scanner and the image forming apparatus may support a PictBridge™ function.

According to an aspect of the present invention, there is provided a computer readable medium having recorded thereon a computer readable program for performing the method.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a conceptual diagram of a conventional image forming system;

FIG. 2 is a block diagram of an image forming system according to an embodiment of the present invention;

FIG. 3 is a conceptual diagram of an image forming system according to an embodiment of the present invention;

FIG. 4 is a flowchart of an image forming method for an image forming system according to an embodiment of the present invention; and

FIG. 5 is a flowchart of an image forming method for an image forming system according to another embodiment of the present invention.

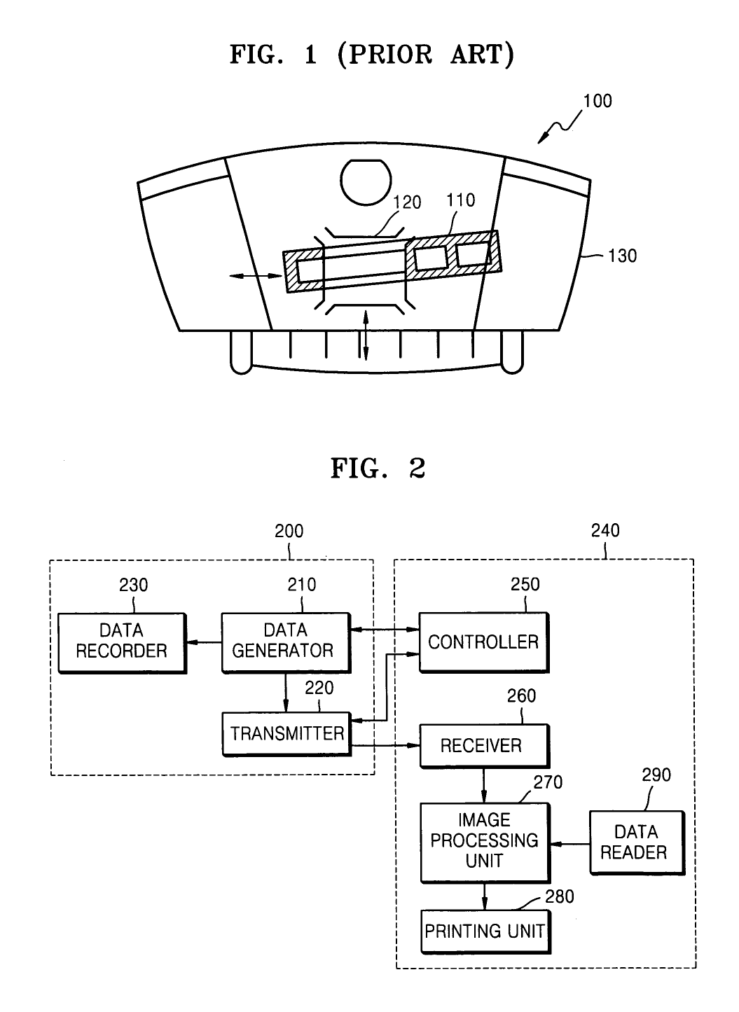

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An image forming system and method according to embodiments of the present invention will now be described more fully with reference to the accompanying drawings.

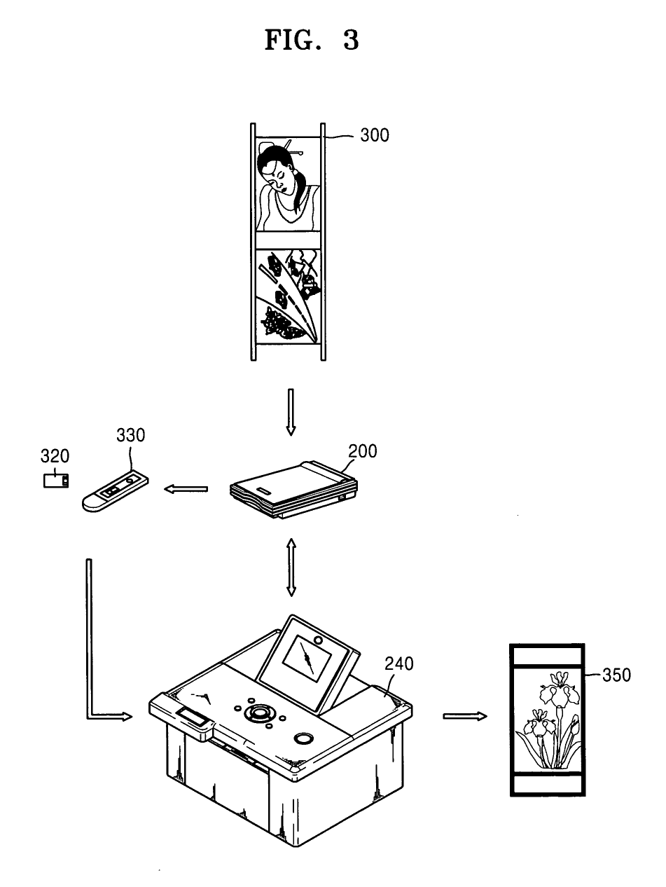

FIG. 2 is a block diagram of an image forming system according to an embodiment of the present invention. The image forming system includes a film scanner 200 and an image forming apparatus 240. An operation of the image forming system according to an embodiment of the present invention will now be described with reference to FIG. 3.

The film scanner 200 generates image data by scanning a film 300 that had been photographed by an analog camera and then developed. Here, the film scanner 200 could be separate or separable from the image forming apparatus 240. Further, film scanner 200 could be portable. Still further, film scanner 200 could operate with an individual, unique function even if it is disconnected from the image forming apparatus 240. In addition, the film scanner 200 can be connected and/or communicably coupled to the image forming apparatus 240 and transmit/receive data or a signal. Thus, unlike a conventional multi-function peripheral (MFP) that includes a film scanner and a image forming apparatus in one body, film scanner 200 could perform a unique function as an individual portable peripheral and is operable with image forming apparatus 240 by being connected and/or communicably coupled thereto.

The film scanner 200 includes a data generator 210, a transmitter 220, and a data recorder 230.

The data generator 210 generates image data by scanning the developed film 300.

The transmitter 220 transmits the image data generated by the data generator 210 to a receiver 260 of the image forming apparatus 240.

The data recorder 230 writes the image data generated by the data generator 210 in a storage medium such as a memory card 320, a USB drive 330, or a memory (not shown) placed in the film scanner 200.

The image forming apparatus 240 prints image data generated by the film scanner 200.

The image forming apparatus 240 includes a controller 250, the receiver 260, an image processing unit 270, a printing unit 280, and a data reader 290.

The controller 250 controls the film scanner 200 that is connected and/or communicably coupled to the image forming apparatus 240. Here, the controller 250 examines the compatibility between the film scanner 200 and the image forming apparatus 240. If it is determined that the film scanner 200 and the image forming apparatus 240 are not compatible, the controller 250 cuts off the connection and/or communication with the film scanner 200.

The controller 250 controls the receiver 260 to receive image data transmitted from the transmitter 220. The transmitter 220 and the receiver 260 are connected and/or communicably coupled to each other either via an electrical connection, such as cable, or wirelessly, such as Bluetooth. Of course, the transmitter 220 and the receiver 260 may be communicably coupled by any other means so long information and/or data is conveyed. Other exemplary communicable couplings include, capacitive or indicative couplings, infrared communications, or communications via a power line. Additionally, the communicable coupling may include a relay or communications path via another device, network or system, any of which may temporarily store, copy, or modify either the content or form of the information and/or data.

The image processing unit 270 performs image processing, such as color compensation, of the image data received by the receiver 260 or image data read by the data reader 290 according to a certain method.

The printing unit 280 prints the image data image-processed by the image processing unit 270 on a print medium 350.

The data reader 290 reads the image data stored by the data recorder 230 in the storage medium, such as the memory card 320 or the USB drive 330, through a storage medium input unit (not shown) such as a memory card reader or a USB port. Of course, the storage medium may be any type of information or storage device.

The film scanner 200 and the image forming apparatus 240 support a PictBridge™ function.

PictBridge™ is a technique for directly printing on an image forming apparatus from a peripheral, such as a digital camera, via a wired or wireless connection, regardless of manufacturer of the peripheral. Thus, with a PictBridge™ enabled peripheral and an image forming apparatus, image data can be printed without installing a driver and/or program in a host device, such as a personal computer.

When the film scanner 200 and the image forming apparatus 240, which support PictBridge™, are connected to each other in a wired or wireless manner, they automatically recognize each other. A view finder of the film scanner 200 is then used to select an image to be printed. Additionally, several functions, a print environment, a number of sheets to be printed, and a size of the print paper could be selected. Exemplary functions include a trimming function for outputting a portion of the image, an index print function for outputting several photos onto print paper as a thumbnail photo, an image cutting function. After a print menu is selected in the film scanner 200, the image data is printed. In addition, when an error occurs in the image forming apparatus 240, a user is informed of the error through a display panel, such as a liquid crystal display (LCD).

When printing is performed using the PictBridge™ function, a state of the printing is displayed on display panel, such as a liquid crystal display (LCD) monitor, of the film scanner 200. In an exemplary implementation, additional information is displayed in real time to the user. Such information includes a confirmation message that the film scanner 200 is connected to the image forming apparatus 240, an error, a state of the printing, an end of printing indication, and an indication that film scanner 200 has been safely disconnected. The above-described print task, related to the PictBridge™ function, for printing using the film scanner 200 can be achieved in the image forming apparatus 240 as well.

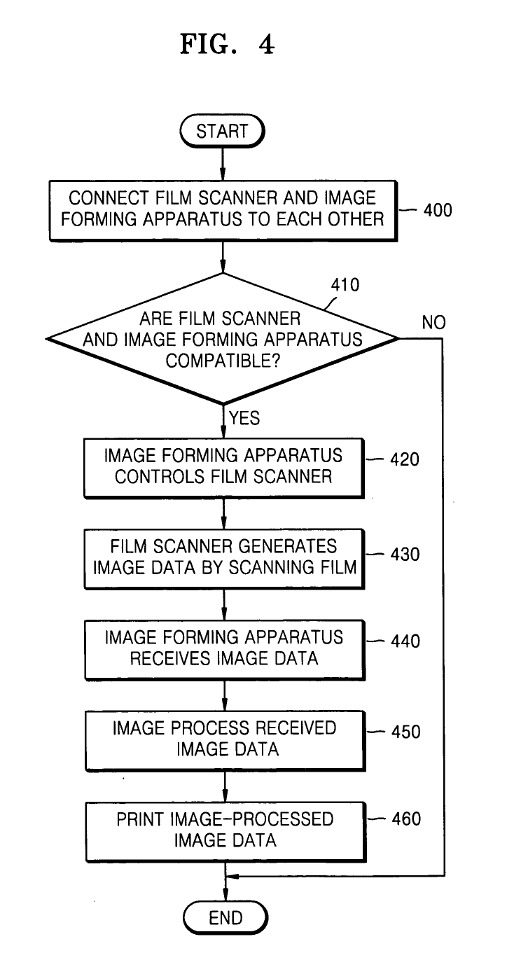

FIG. 4 is a flowchart of an image forming method for an image forming system according to an embodiment of the present invention. The image forming apparatus receives and prints image data generated by scanning a developed film in a film scanner located apart from and connectable and/or communicably coupled to the image forming apparatus.

Referring to FIG. 4, in operation 400, the film scanner and the image forming apparatus are connected to each other in a wired or wireless manner.

In operation 410, the image forming apparatus determines whether it is compatible with the film scanner.

If the image forming apparatus determines that it is compatible with the film scanner, in operation 420, the image forming apparatus controls the film scanner.

In operation 430, the film scanner generates image data by scanning a developed film.

In operation 440, the image forming apparatus controls the film scanner to transmit the generated image data to the image forming apparatus. In another embodiment, without performing operation 430, in operation 440, the image forming apparatus can read stored image data from a storage medium equipped in the film scanner in which image data generated by scanning a developed film is stored.

In operation 450, an image processing operation, such as color compensation, on the transmitted image data is performed according to a predetermined method.

In operation 460, the image forming apparatus prints the image-processed image data on a print medium.

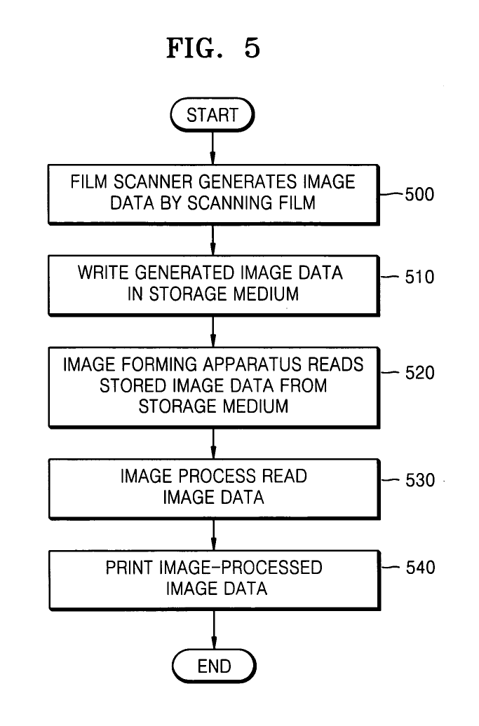

FIG. 5 is a flowchart of an image forming method for an image forming system according to another embodiment of the present invention.

Referring to FIG. 5, in operation 500, a film scanner generates image data by scanning a developed film.

In operation 510, the generated image data is written in a storage medium such as a memory card or a USB drive.

In operation 520, the storage medium in which the written image data is stored is inserted into a storage medium input unit equipped in an image forming apparatus, such as a memory card reader or a USB port, and the image data is read from the inserted storage medium.

In operation 530, an image processing operation, such as color compensation, on the read image data is performed according to a certain method.

In operation 540, the image forming apparatus prints the image-processed image data on a print medium.

The present invention may be embodied in a general-purpose computer by running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet).

As described above, in an image forming system and an image forming method according to embodiments of the present invention, an image forming apparatus controls a film scanner located apart from the image forming apparatus and connectable and/or communicably coupled to image forming apparatus and thereby prints image data.

Thus, the size of the image forming system can be reduced, and since the film scanner is separable or separate from the image forming apparatus, a user can conveniently use the film scanner.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An image forming system comprising:
a film scanner for generating image data by scanning a film; and
an image forming apparatus for printing the generated image data,
wherein the film scanner is separable or separate from and is connectable or communicably coupled to the image forming apparatus, and
the image forming apparatus controls the film scanner and receives the generated image data.

2. The system of claim 1, wherein the image forming apparatus comprises:
a controller for controlling the film scanner;
a receiver for receiving the generated image data by controlling the controller; and
a printing unit for printing the received image data.

3. The system of claim 2, wherein the film scanner comprises:
a data generator for generating image data by scanning a film; and
a transmitter for transmitting the generated image data to the image forming apparatus.

4. The system of claim 3, wherein the receiver and the transmitter are connected and/or communicably coupled to each other in at least one of a wired and wireless manner.

5. The system of claim 1, wherein the film scanner further comprises a data recorder for writing the generated image data in a storage medium.

6. The system of claim 1, wherein the image forming apparatus further comprises a data reader for reading the written image data from the storage medium.

7. The system of claim 2, wherein the image forming apparatus further comprises:
an image processing unit for performing an image processing operation on the received image data,
wherein the printing unit prints the image-processed image data.

8. The system of claim 1, wherein the film scanner is portable.

9. The system of claim 1, wherein at least one of the film scanner and the image forming apparatus support a PictBridge™ function.

10. A film scanner for generating image data by scanning film, the film scanner comprising:
a data transmitter for transmitting the generated image data to an image forming apparatus according to a control of the image forming apparatus,
wherein the film scanner is separable or separate from and is connectable or communicably coupled to the image forming apparatus.

11. The film scanner of claim 10, further comprising:
a data recorder for writing the generated image data in a storage medium.

12. The film scanner of claim 10, wherein the film scanner is portable.

13. The film scanner of claim 10, wherein the film scanner supports a PictBridge™ function.

14. An image forming apparatus comprising:
a controller for controlling a film scanner, the film scanner being separable or separate from and being connectable or communicably coupled to the image forming apparatus, to receive image data generated by scanning a film in the film scanner; and
a printing unit for printing the received image data.

15. The apparatus of claim 14, wherein the image forming apparatus supports a PictBridge™ function.

16. An image forming method for an image forming system in which an image forming apparatus receives and prints image data generated by scanning a film in a film scanner separable or separate from and is connectable or communicably coupled to the image forming apparatus, the method comprising:
connecting the film scanner to the image forming apparatus;
generating image data by scanning a film;
receiving the generated image data at the image forming apparatus by controlling the film scanner; and
printing the received image data in the image forming apparatus.

17. The method of claim 16, further comprising:
determining whether the image forming apparatus is compatible with the film scanner; and
terminating the connection between the image forming apparatus and the film scanner if the image forming apparatus and the film scanner are not compatible.

18. The method of claim 16, further comprising:
performing an image processing operation on the transmitted image data,
wherein the printing comprises printing the image-processed image data.

19. The method of claim 16, wherein the film scanner is portable.

20. The method of claim 16, wherein at least one of the film scanner and the image forming apparatus support a PictBridge™ function.

21. A computer readable medium having recorded thereon a computer readable program for performing the method of claim 16.

22. A computer-readable recording medium storing a program for implementing an image forming method for an image forming apparatus, wherein the image forming apparatus is separable or separate from and is connectable or communicably coupled to the film scanner, the method comprising:
receiving image data generated by the film scanner at the image forming apparatus; and
printing the received image data in the image forming apparatus.

23. A computer-readable recording medium storing a program for implementing an scanning method for a film scanner that is separable or separate from and is connectable or communicably coupled to an image forming apparatus, the method comprising:
generating image data by scanning a film; and
sending the generated image data to the image forming apparatus.
